(19) United States
(12) Patent Application Publication
(10) Pub. No.: US 2017/0249328 A1
(43) Pub. Date: Aug. 31, 2017

(54) A Method, Cloud Synchronization Function Means and File System for Handling Files and Directories in a Cloud Storage Service

(71) Applicant: Telefonaktiebolaget LM Ericsson (publ), Stockholm (SE)

(72) Inventors: Hongxin Liang, Upplands Väsby (SE); Leonid Mokrushin, Uppsala (SE); Sébastien Pierrel, Sundbyberg (SE)

(73) Assignee: Telefonaktiebolaget LM Ericsson (publ), Stockholm (SE)

(21) Appl. No.: 15/507,660

(22) PCT Filed: Sep. 2, 2014
(86) PCT No.: PCT/SE2014/051009

§ 371 Date: Feb. 28, 2017

(51) Int. Cl. G06F 17/30

(52) U.S. Cl. CPC G06F 17/30174; G06F 17/30194

(57) ABSTRACT

The present invention relates to a method and a cloud synchronization function means (118) of a user device (100) for handling files and directories in a cloud storage service, the user device comprises a processing unit (110) adapted to perform: receiving (S110) a notification from a file system (116) of the user device that one or more files in the file system have been cloud tagged by a user of the user device to be synchronized with the cloud storage service; retrieving (S120) the cloud tagged file or files from the file system; sending (S130) the cloud tagged file or files to the cloud storage service.

### TECHNICAL FIELD

The present technology relates to a method, a means and a file system for handling files and directories in a cloud storage service.

### BACKGROUND

Today there exits quite a few cloud storage services, for example, Dropbox, Google Drive, OneDrive, Box, etc.

The way they keep track of files is by offering a special directory where the user can put any kind of files and they will be synchronized across different devices of the user. Some of those services provide Web-based Distributed Authoring and Versioning, WebDAV, for example enabling the user mapping the cloud storage service as a local disk that is no difference from a directory from the user's point of view.

This works perfectly OK, while the user has to copy/move files around in order to put them to the cloud. The drawbacks of such approach are suboptimal user experience and duplication of files. Moreover, the position of the synchronized file relative to the Operating System, OS, file system is not preserved when using copy/move approach to store files in the cloud.

Most of the cloud storage services have a special running cloud synchronization function, sometimes denoted daemon, monitoring a specified directory or a mapped disk, and this daemon is responsible for synchronizing files with the cloud storage service and across different devices.

As having been phrased above, in order to put a file to the cloud storage, the user has to copy/move files into a special directory. Said moving procedure sometimes results in a bad user experience and duplications of files. And existing solutions do not provide system-wide fine-grained synchronization, meaning that the user cannot easily specify an arbitrary file anywhere in the file system to be stored into a cloud and synchronized with the other devices.

### SUMMARY

The object of this disclosure is to provide an alternative solution to the existing method for putting a file to the cloud storage, and thereby eliminating the bad user experience and duplications of files.

According to one aspect, a method and embodiments thereof are provided, wherein said method for a user device is a method of handling files and directories in a cloud storage service. Said method comprises a step of receiving a notification from a file system of the user device that one or more files in the file system have been cloud tagged by a user of the user device to be synchronized with the cloud storage service. Said method further comprises a retrieving of the cloud tagged file or files from the file system, and a sending of the cloud tagged file or files to the cloud storage service.

According to yet another aspect, a cloud synchronization function means and embodiments thereof is provided herein. The cloud synchronization function means of a user device is adapted for handling files and directories in a cloud storage service. The user device comprises a processing unit, which is adapted to receive a notification from a file system of the user device that one or more files in the file system have been cloud tagged by a user of the user device to be synchronized with the cloud storage service. The processing unit is further adapted to retrieve the cloud tagged file or files from the file system, and to send the cloud tagged file or files to the cloud storage service.

According to further one aspect, a file system is also provided herein. The user device comprises a processing unit capable of handling said file system, which processing unit 110 is adapted to generate and send a notification to a cloud synchronization function 118 of the user device that one or more files in the file system have been cloud tagged.

One advantage over prior art, is that the proposed method and means provide a more convenient way of storing files and directories in the cloud. The drawbacks experienced by copying/moving the files and directories to a special synchronized directory are avoided. The proposed method and means offers a finer grained manner than prior art does.

### BRIEF DESCRIPTION OF THE DRAWINGS

The foregoing, and other, objects, features and advantages of the present invention will be more readily understood upon reading the following detailed description in conjunction with the drawings in which:

FIG. 1 is a signaling scheme illustrating a method for putting a file to the cloud storage;

FIG. 2 is a flowchart illustrating a method in a user device

FIG. 3 is a flowchart illustrating an embodiment of the method in FIG. 1;

FIG. 4 is a signaling scheme illustrating a sub-process of the method;

FIG. 5 is a flowchart illustrating an embodiment of the sub-process illustrated in FIG. 4;

FIG. 6 is a signaling scheme illustrating a sub-process of the method;

FIG. 7 is a flowchart illustrating an embodiment of the sub-process illustrated in FIG. 6;

FIG. 8 is a signaling scheme illustrating a sub-process of the method;

FIG. 9 is a signaling scheme illustrating a sub-process of the method;

FIG. 10 is a signaling scheme illustrating a sub-process of the method;

FIG. 11 is a flowchart illustrating an embodiment of the sub-process illustrated in FIG. 8;

FIG. 12 is a flowchart illustrating an embodiment of the sub-process illustrated in FIG. 9;

FIG. 13 is a flowchart illustrating an embodiment of the sub-process illustrated in FIG. 10;

FIG. 14 is a signaling scheme illustrating a sub-process of the method;

FIG. 15 is a flowchart illustrating an embodiment of the sub-process illustrated in FIG. 14;

FIG. 16 is a signaling scheme illustrating a sub-process of the method;

FIG. 17 is a flowchart illustrating an embodiment of the sub-process illustrated in FIG. 16;

FIG. 18 is a signaling scheme illustrating a sub-process of the method;

FIG. 19 is a flowchart illustrating an embodiment of the sub-process illustrated in FIG. 18;

FIG. 20 is a block diagram of a user device comprising a cloud synchronization function.

### DETAILED DESCRIPTION

In the following description, for purposes of explanation and not limitation, specific details are set forth, such as particular circuits, circuit components, techniques, etc. in order to provide a thorough understanding of the present technology. However, it will be apparent to one skilled in the art that the present technology may be practiced in other embodiments that depart from these specific details. In other instances, detailed descriptions of well-known methods, devices, and circuits are omitted so as not to obscure the description of the present technology with unnecessary detail.

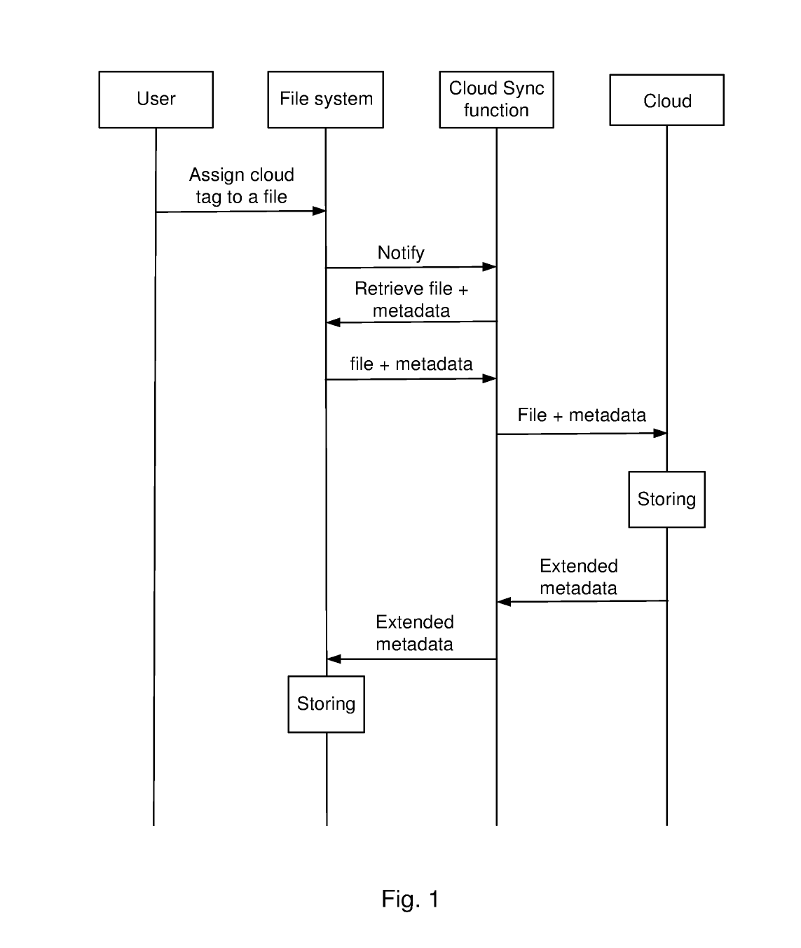

The transferring of files, messages and commands according to the provided method is hereafter described and illustrated with reference to the accompanying drawings, starting with FIG. 1.

FIG. 1 is a signaling scheme illustrating the flow of signals, messages and files between a user device and a cloud storage service located in the cloud. The user device is handled by a user that is able to control the device by pressing keys on a keyboard, entering commands, starting software applications (abbreviated: apps), etc. The user device comprises an operating software system running in a processor unit comprising one or more processors and memory storages. The user device comprises a file system for enabling the user to handle files and directories storing the files. The device further comprises a communication interface for enabling transmission and reception of data packets comprising commands, messages, calls, files, etc.

The user device further comprises a cloud synchronization function for enabling transferring of files or directories between the file system of the user device and the cloud storage service in the cloud.

A data device is herein any communication device, or user equipment, operating in the radio frequency region. Examples of data devices are smart phones, laptops, mobile terminals, tablets (e.g. Ipads) etc. A data device comprises at least one receiver and/or transmitter or a transceiver, which is a combined receiver and transmitter.

The cloud storage service is a service offering storage of files of different kinds in the cloud, or internet.

The user has decided to store some files or a directory with files in the cloud. In accordance with prior art, the user would have moved the file or files by dragging the file or files from its ordinary place in the file system to a special synchronization directory.

According the herein provided technique, the user instead tags the name of the file with a cloud tagging, or cloud marking in its ordinary directory in the file system. An example of such claim tagging is a suitable pre-determined word or abbreviation, e.g. “_cloud_”, “.cld”, etc.

The file system organizes files and directories. When the file system finds a file that has been cloud tagged, it is adapted to generate and send a notification to the cloud synchronization function that one or more files in the file system have been cloud tagged by a user of the user device.

As illustrated in FIG. 1, the cloud synchronization function receives the notification. The cloud synchronization function retrieves the cloud tagged file or files from the file system, and sends the cloud tagged file or files to the cloud storage service. The cloud storage service stores the received files in any of its available storages.

Tagging a directory means tagging the directory itself and all files and sub directories under that directory. Changes in the file system can also be versioned in order to enable rollback functionality.

The user can tag a group of files by configuring a rule, for example files ending with “.docx” will be automatically tagged with “_cloud_”.

Without loss of generality, it is not differentiated between file and directory in this disclosure.

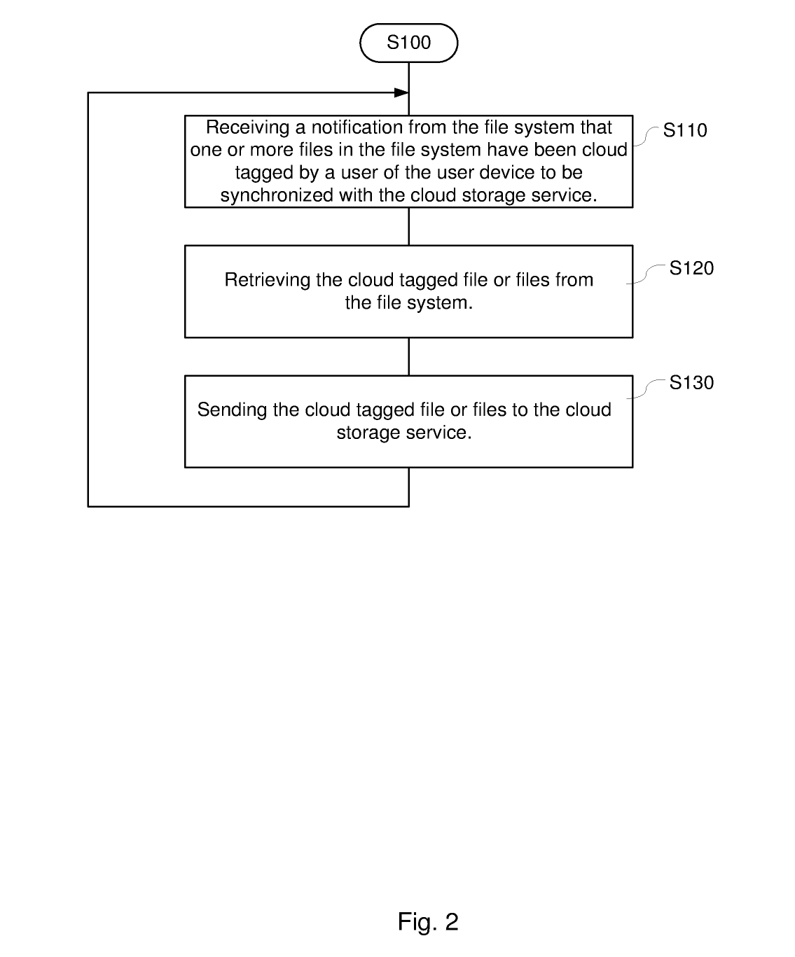

FIG. 2 is a flowchart illustrating a method in a user device. The method enables a user of the user device to handle files and directories in a cloud storage service and in a file system of the user device. Said method comprises the steps of:

S110: receiving a notification from the file system that one or more files in the file system have been cloud tagged by a user of the user device to be synchronized with the cloud storage service.

S120: retrieving the cloud tagged file or files from the file system;

S130: sending the cloud tagged file or files to the cloud storage service.

The method may be performed by a cloud synchronization function in the user device.

As it is further illustrated in FIG. 1, the file system generates and sends metadata for the cloud tagged file or files from the file system. The cloud synchronization function then sends the received metadata of the cloud tagged file or files to the cloud storage service, which stores said metadata.

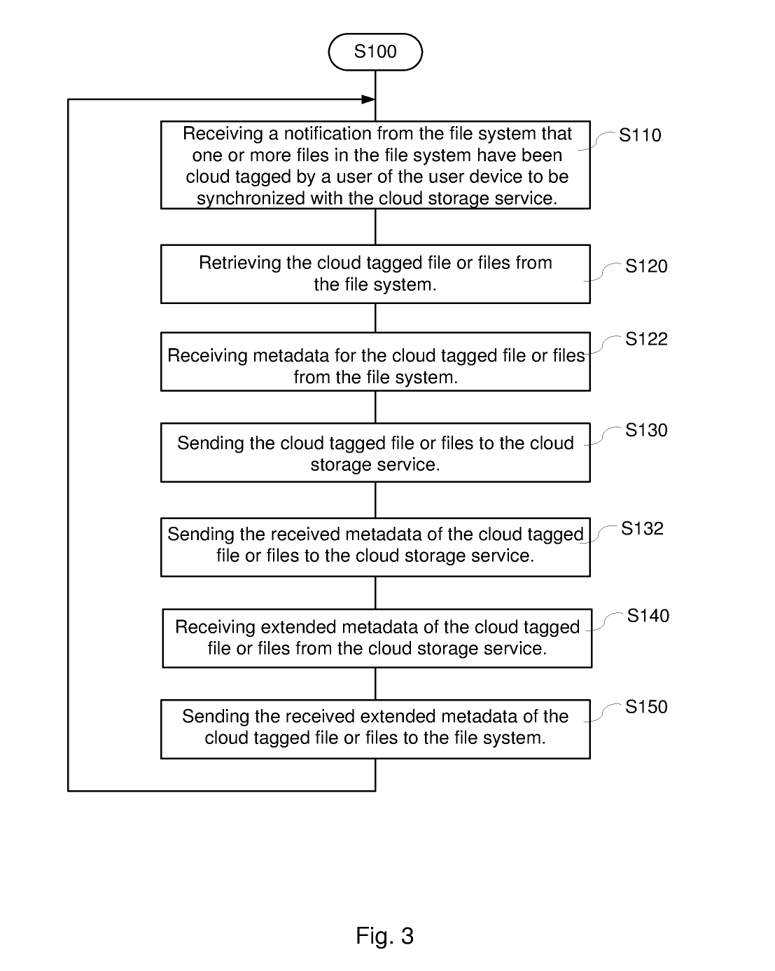

FIG. 3 is a flowchart illustrating an embodiment of the above described method. The method further comprises the steps of:

S122: receiving metadata for the cloud tagged file or files from the file system;
S132: sending the received metadata of the cloud tagged file or files to the cloud storage service.

As it is further illustrated in FIG. 1, the cloud storage service generates and sends extended metadata for the stored cloud tagged file or files to the cloud synchronization function. The cloud synchronization function receives and sends the received extended metadata of the cloud tagged file or files to the file system, which stores said extended metadata.

Thus, according to one embodiment of the method, said method may further comprise the steps of:

S140: receiving extended metadata of the cloud tagged file or files from the cloud storage service;

S150: sending the received extended metadata of the cloud tagged file or files to the file system.

There is no limitation where to store metadata and extended metadata.

Both can be stored as file attributes and extended file attributes, as separate plain files, or in a database, e.g. a relational database.

Metadata here includes but not limited to:
File path
Creation time
Last modification time
Ownership

Extended metadata includes but not limited to:
Current version
Generated ID pointing to the file in cloud
   Cloud does not have to keep exactly the same path of the file or directory, but just a hash;
   A specific version of a file can be identified by ID+current version.

The above described method and embodiments thereof enable a number of possibilities to handle files and directories stored in a user device's file system and in the cloud storage service.

One such possibility is to update an already tagged file or directory in the cloud storage service.

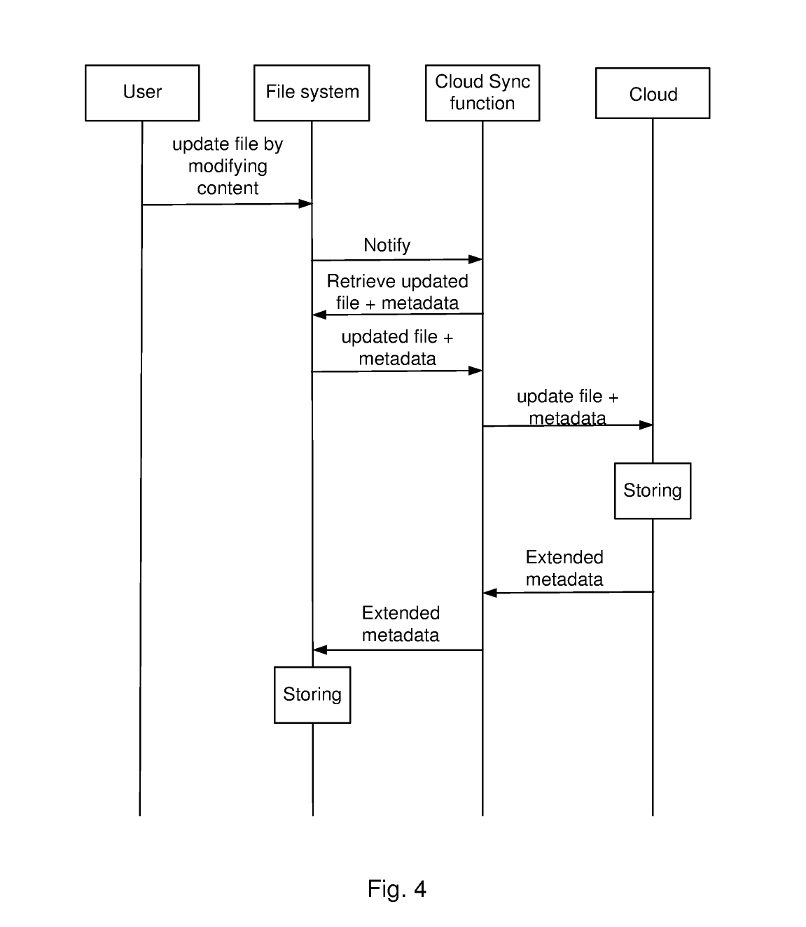

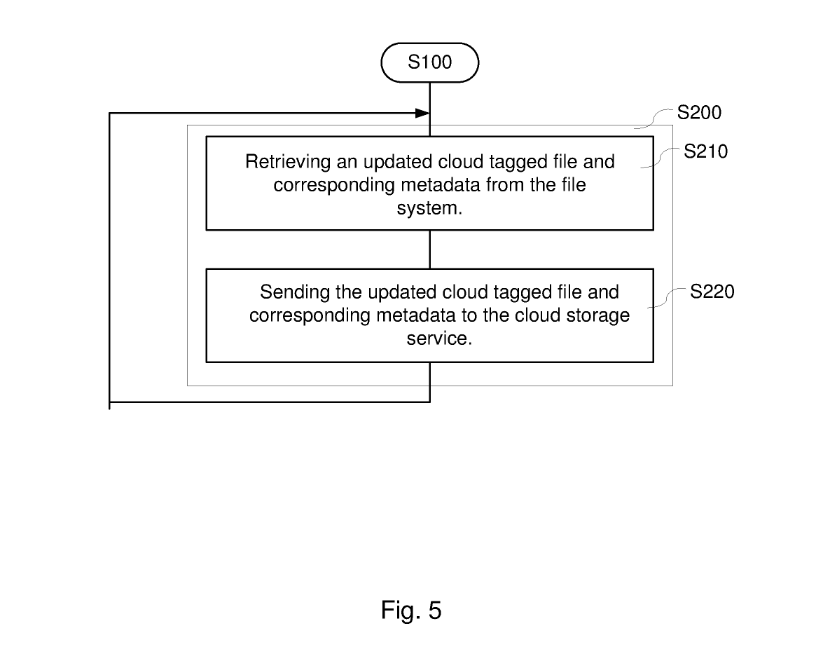

The sub-process S200 to update an already tagged file or directory in the cloud storage service is illustrated in the signaling scheme of FIG. 4 and flowchart of FIG. 5.

The user retrieves a file of interest in the file system, and updates it by amending its content. The user closes the file with the modified content, which file is stored in the file system. As the file is cloud tagged, the file system generates and sends a notification to the cloud synchronization function, which is configured to perform following steps of the sub-process S200:

S210: retrieving an updated cloud tagged file and corresponding metadata from the file system;
S220: sending the updated cloud tagged file and corresponding metadata to the cloud storage service.

The cloud storage service receives the updated cloud tagged file and its updated metadata and stores the file and metadata. It may generate updated extended metadata, which is sent to the cloud synchronization function, which forwards the updated extended metadata to the file system wherein it is stored.

A new version of the file will be included in updated extended metadata while ID keeps unchanged.

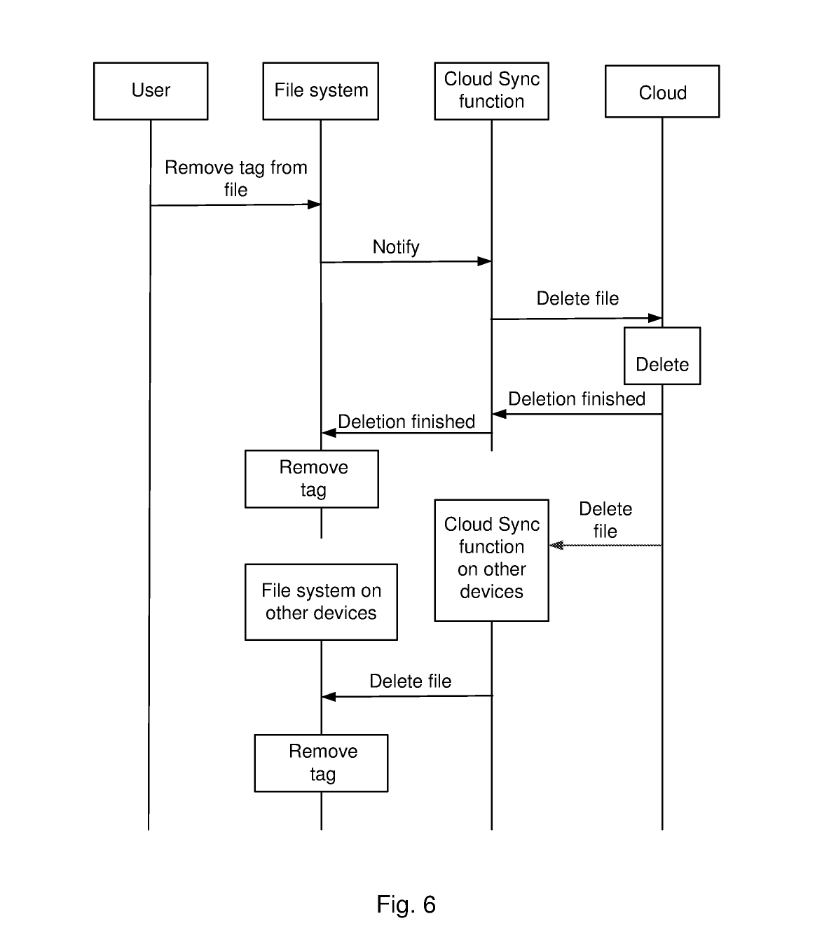

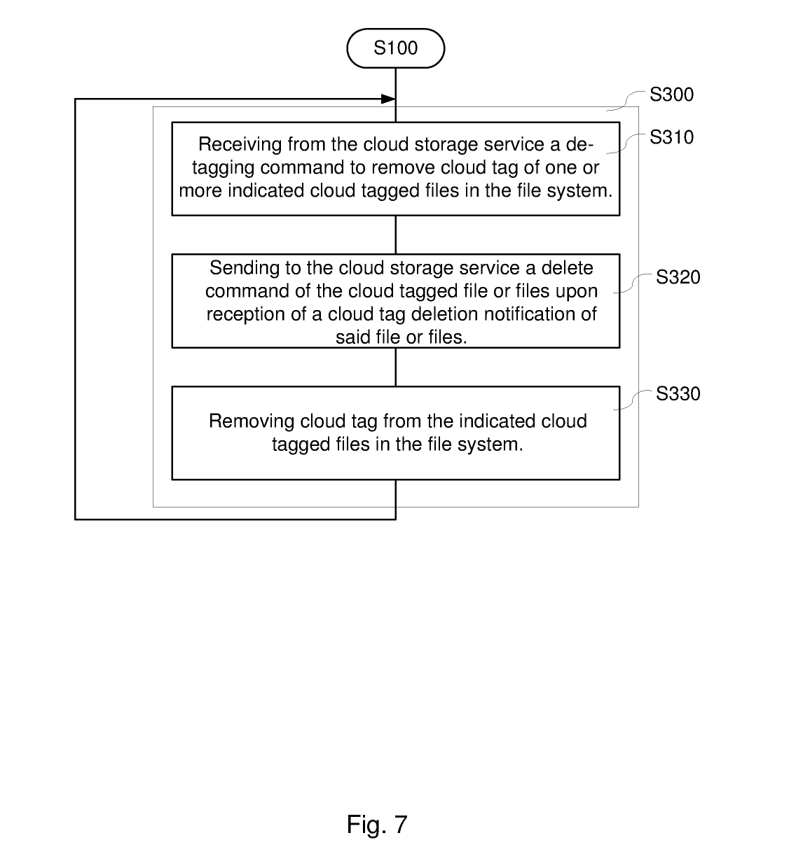

One sub-process S300 of the method is a sub-process of de-tagging a file or directory. Said sub-process is illustrated in FIGS. 6 and 7.

FIG. 6 is a signaling scheme illustrating the signaling between the user, file system, cloud synchronization function and cloud storage service when a file is de-tagged.

A user of the user device may want to remove or delete a file or directory from the cloud storage service. The user then opens the file systems and instructs the file system to remove the cloud tag from the file. The file system sends a notification that the cloud tag for a file or directory is to be removed. The cloud synchronization function receives said notification and sends a delete file message to the cloud storage service. The cloud storage service receives the delete file message and deletes the file. The cloud storage service may thereafter send a deletion finished to the cloud synchronization function, which receives the notification and forwards said notification to the file system as a confirmation of the file deletion.

FIG. 7 is a flowchart illustrating a sub-process S300 for de-tagging a file or directory, said sub-process being performed by the cloud synchronization function in the user device.

As illustrated in FIG. 7, the sub-process may comprise:

S310: sending to the cloud storage service a delete command of the cloud tagged file or files upon reception of a cloud tag deletion notification of said file or files from the file system;
S320: sending a deletion finished confirmation to the file system. As described above, a deletion finished confirmation may be sent to the file system after the cloud synchronization function has received a deletion finished from the cloud storage service.

Other user devices may also have a copy of the removed file or directory in its file system. The cloud storage service has a list of user devices for each file stored in the cloud storage service. It is therefore possible to de-tag corresponding file in the file system of other user devices. The sub-process of de-tagging a file or directory in a user device may therefore comprise:

S330: receiving from the cloud storage service a de-tagging command to remove cloud tag of one or more indicated cloud tagged files in the file system; and

S340: sending a delete cloud tag from the indicated cloud tagged files in the file system.

The sub-process can be configured whether to delete the de-tagged file from all devices, or keep it. Thus, steps S330 and S340 may be optional.

Deleting the already tagged file or directory locally on one device will not affect the file or directory stored in cloud and any other devices.

Copying or moving already tagged file or directory locally on one device will not affect the file or directory stored in cloud and any other devices, and the destination file on the device will automatically be de-tagged locally.

As illustrated above, a tagged file or directory may be versioned, and this is done in the cloud whenever a file is updated by a device.

File update on one device will be propagated to all devices owned by the user automatically.

Previous versions are kept in which case the user can already roll back. Actual number of versions can be specified in a contract between the cloud provider and the user.

The user can ask cloud synchronization function to show a list of versions of a specified file or directory specified by an ID.

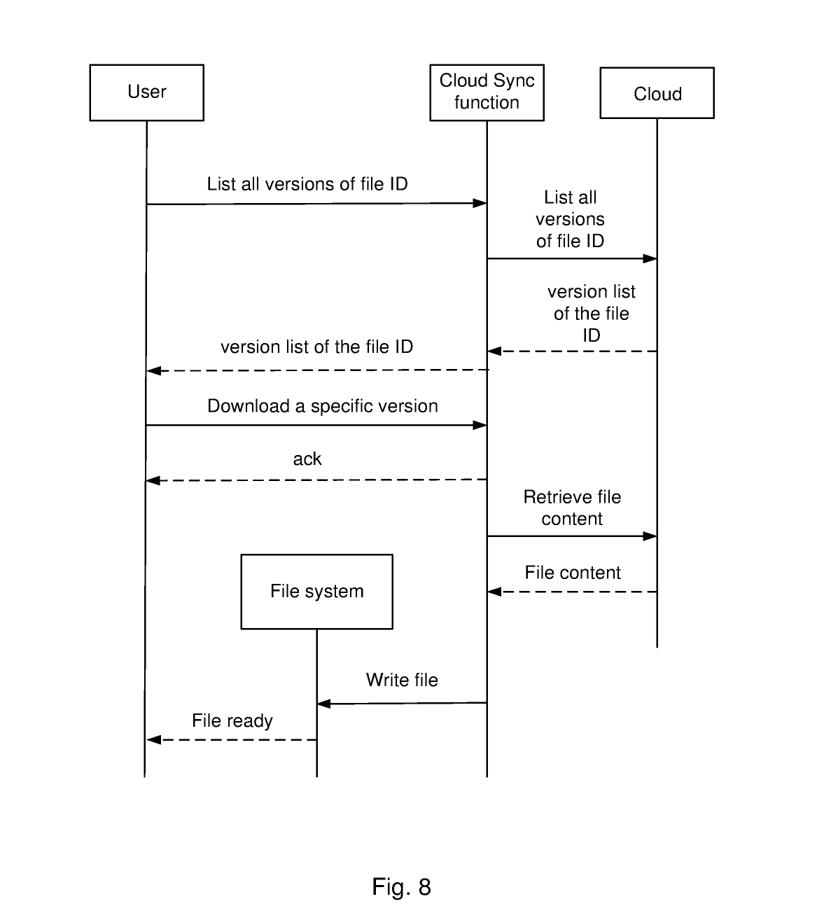

The method S100 may further comprise a sub-process S400 of listing all versions of a cloud tagged file in the cloud storage service and download a specific version of the file from the cloud storage service into the file system. Said sub-process is illustrated in FIG. 8. FIG. 8 is a signaling scheme comprising the sub-process S400. The user instructs the file system to “request a list off all versions of file ID” File ID is the file identity, i.e. the file name. The cloud synchronization function receives the request and forwards said request to the cloud storage service, which performs a search for the requested file ID and its versions. The search results in a list which is sent to the user device and received by the cloud synchronization function. The user is now able to look at the list on a display and order to download a specific version specified on the list from the cloud storage service. The cloud synchronization function of the user device receives the order and generates an acknowledgement to the user. The cloud synchronization function sends the order to the cloud storage service, which responds by sending the file and its file content to the user device. The cloud synchronization function writes the file and its content into the file system, which informs the user (by means of the display) that the file is ready.

The method S100 may also comprise a sub-process S500 of listing all new added cloud tagged files in the cloud storage service and download new added cloud tagged files from the cloud storage service into the file system.

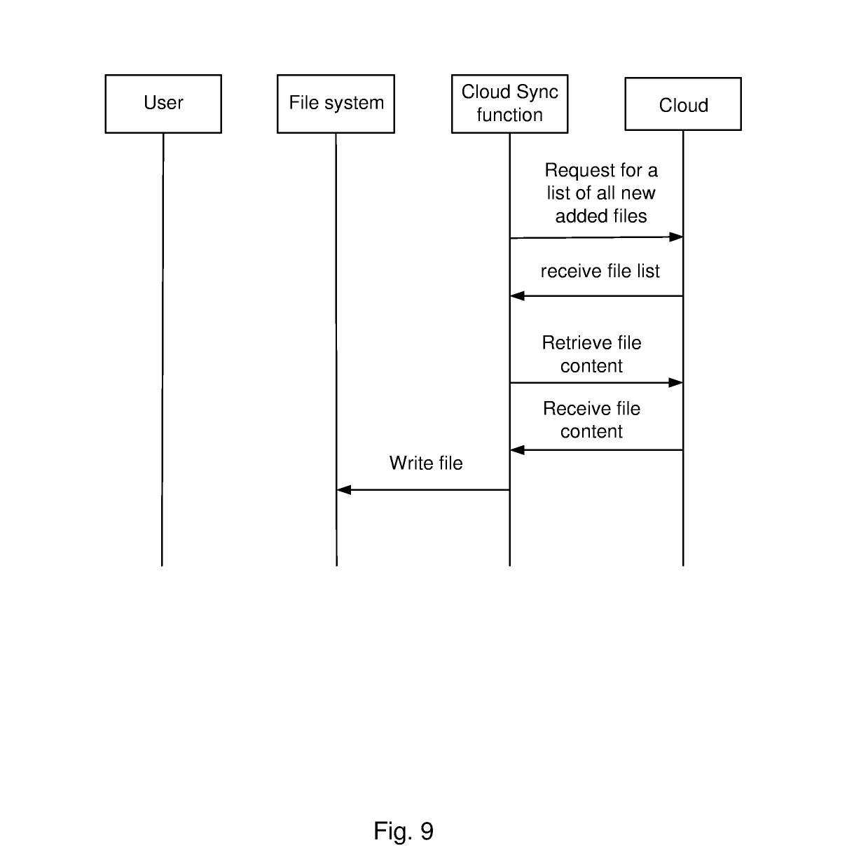

FIG. 9 is a signaling scheme illustrating the listing sub-process.

The cloud synchronization function may be configured to automatically download file or directory tagged on other devices automatically to current device regardless of any human interaction even when no application/process is trying to access the file, and the file will be kept locally until the user explicitly deletes it from the device.

The cloud synchronization function sends a request for a list of all new added files to the cloud storage service, which receives the request, makes a search for all new added files and sends the result of the search as a list back to the cloud synchronization function. The cloud synchronization function receives the list. The list comprises the file names and their corresponding metadata and extended metadata, but no content of the new added files. The cloud synchronization function may automatically, as an option, retrieve the file content of all files by sending a request for their file content.

The cloud storage service retrieves the content corresponding to each file name, the corresponding metadata and extended metadata and sends the content one by one, or as a batch. The cloud synchronization function and the file system cooperate to write the received file name and content into the file system.

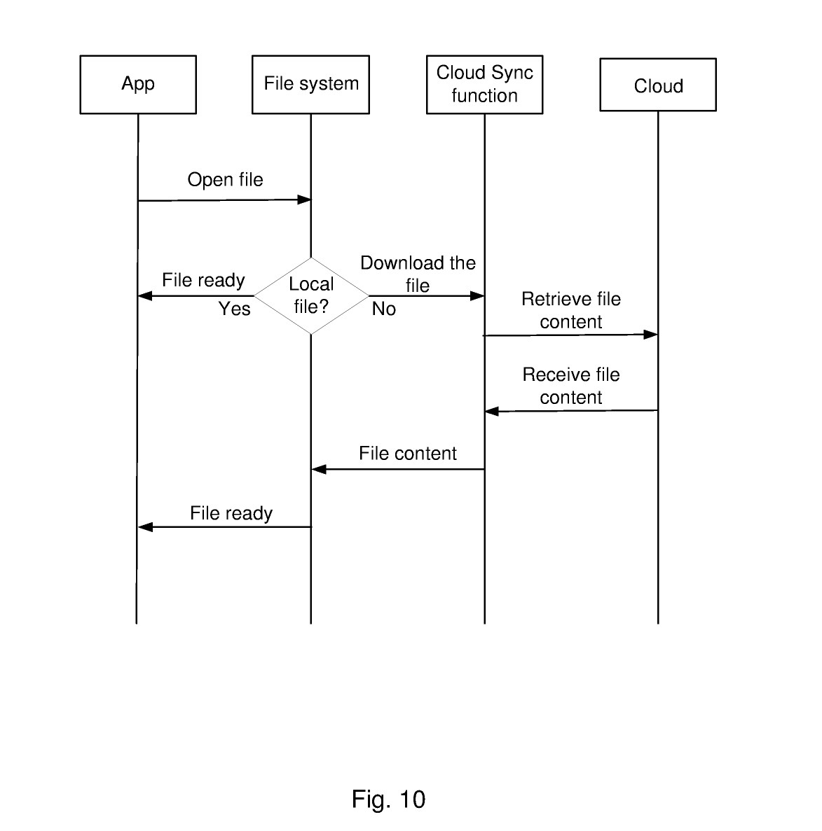

In FIG. 10 is yet another sub-process illustrated. The sub-process S600 of the method S100 is a process of automatically retrieving a cloud tagged file from the cloud storage service to the file system upon an access file command.

A user or a software application, App, wants to get access to a file and an access file command is sent to the file system. The file system is adapted to check if the file is stored in the file system, “Local file?”. If the requested file is a local file, i.e. stored in the file system, a “file ready”-indication is sent to the App or is displayed on the user device display. If the result of the check is “No”, the file system is adapted to send a download file command to the cloud synchronization function, which sends to the cloud storage service a request message for retrieving the file content for the corresponding file name. If the cloud storage service has access to said file, the service responds by sending the file content to the user device, wherein the cloud synchronization function writes the received file content into the file system. The file system sends a “file ready”-indication to the App or to the user device display.

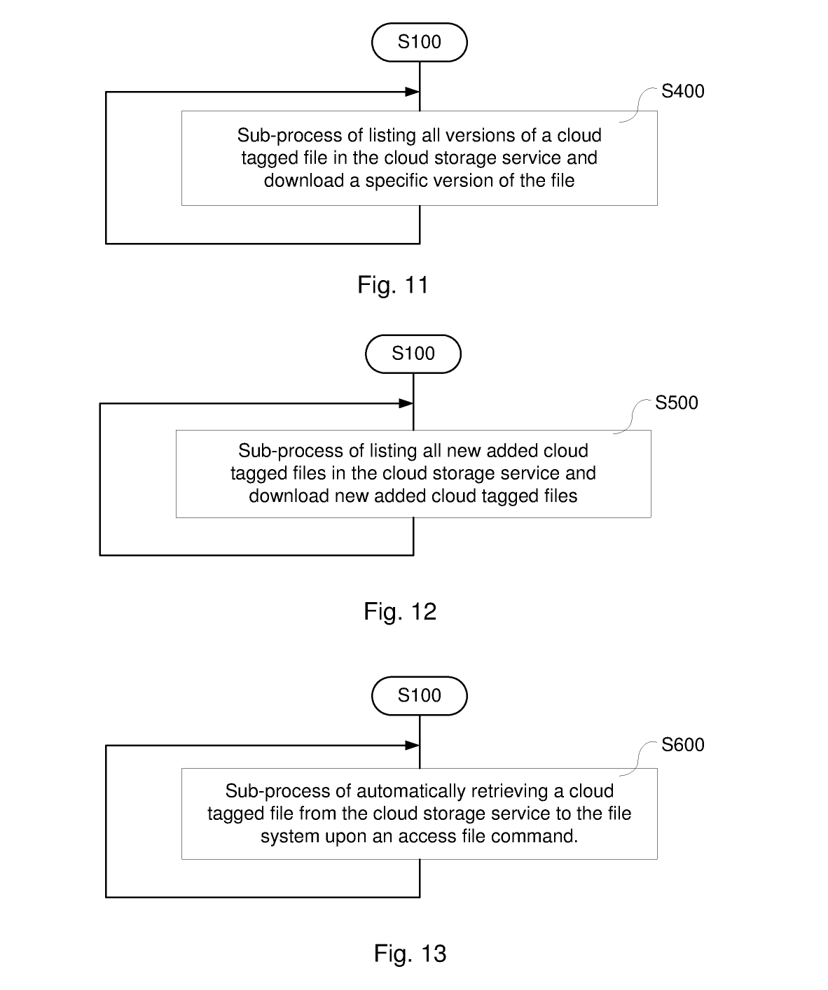

FIGS. 11, 12 and 13 are flowcharts, each indicating that the sub-processes S400, S500 and S600, respectively, is a sub-process dependent of the method S100, wherein a file or directory has been cloud tagged.

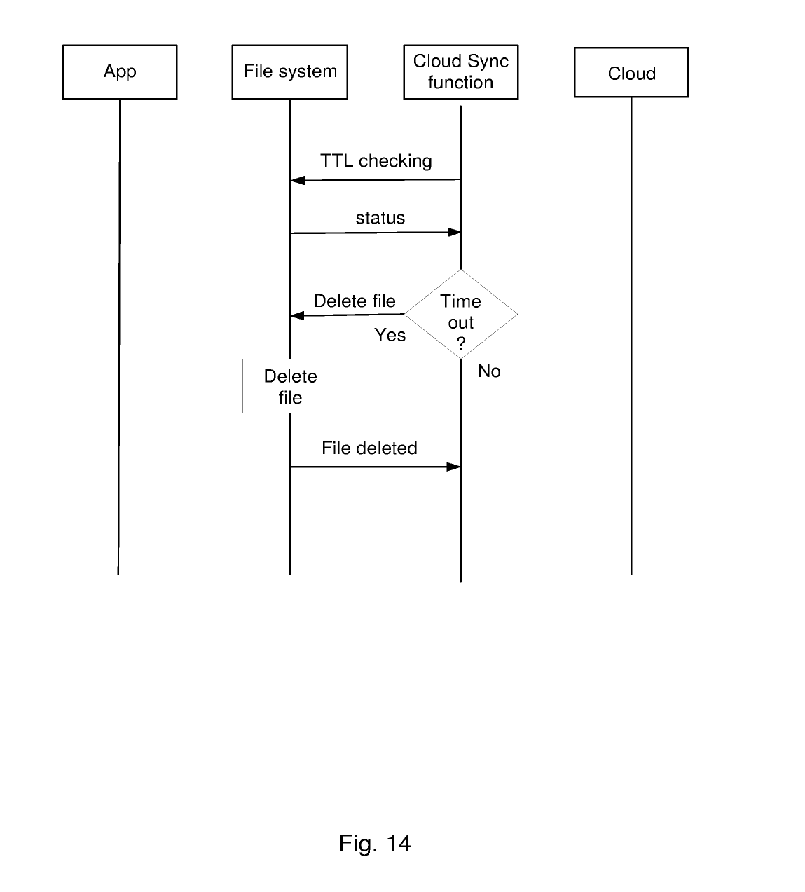

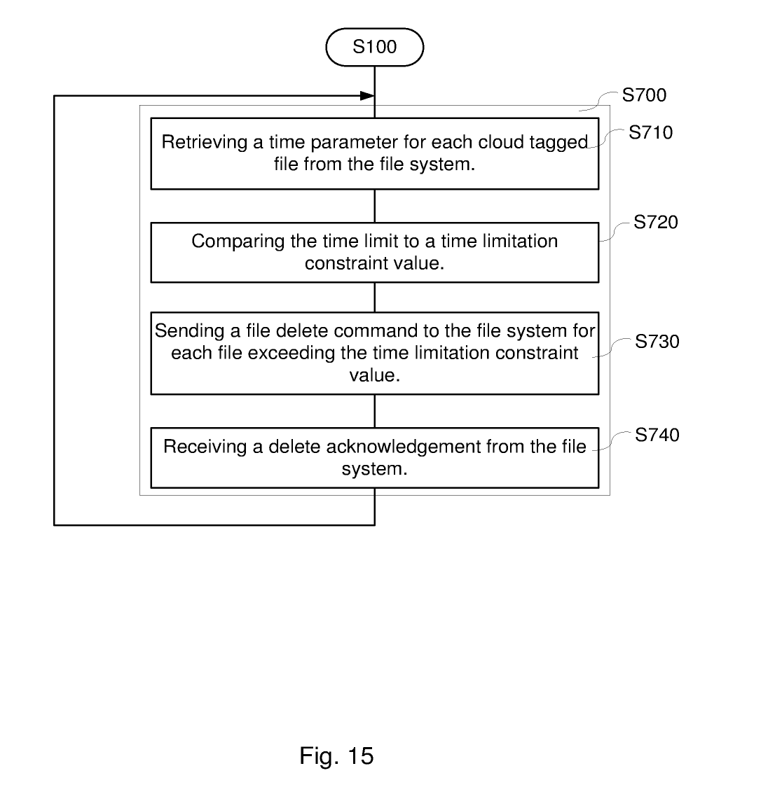

The cloud synchronization function may be configured to use some kind of “Time To Live”-parameter, which TTL-parameter can be used in order to detect when a file can be deleted from the device, for example, if the file hasn't been accessed for certain amount of time, it will be deleted automatically, or whenever there is no application accessing it. Such a sub-process is illustrated in FIG. 14 and FIG. 15.

FIG. 14 is a signaling scheme illustrating a sub-process S700 of checking if cloud tagged files could be deleted due to a set time limit. FIG. 15 is a flowchart of the sub-process of the method S100. The process is based on the existence of a time parameter or time stamp. Said time parameter is set when the file is created in the user device. The parameter may be the date when the file may be deleted, e.g. Time-To-Live, or the date/time when the file was generated, inserted or accessed (or used) in the user device. The time limitation constraint value may be the current date or momentary time. The time limitation constraint value may alternatively be an ultimate time length or age for a file or directory, e.g. from when the file was generated or accessed/used. The comparing of the time parameter to a time limitation constraint value may include some mathematical time calculation. Different suitable mathematical time calculations, formulas or algorithms are well-known in the prior art and may be used herein.

Further, the sub-process may be triggered automatically or manually (by the user). It may be triggered periodically at a pre-set time interval between the executions of the sub-process.

According to FIG. 15, said sub-process may comprises the steps of:

S710: retrieving a time parameter for each cloud tagged file from the file system;
S720: comparing the time parameter to a time limitation constraint value;
S730: sending a file delete command to the file system for each file exceeding the time limitation constraint value;
S740: receiving a delete acknowledgement from the file system.

The sub-process S700 of checking if cloud tagged files could be deleted due to a set time limit is explained with reference to FIG. 14.

When the sub-process S700 is triggered by the cloud synchronization function, step S710, is performed. The retrieving of a time parameter for each cloud tagged file from the file system involves that the cloud synchronization function sends a time status request for all cloud tagged files to the file system, and the reception of a time status list as a result of the file systems time status search.

The cloud synchronization function than performs step S720, wherein the time parameter for each received file is compared to a time limitation constraint value. Each file for which the time parameter exceeds the time limitation constraint value is deemed to be deleted. The cloud synchronization function sends, S730, a file delete command to the file system for each file exceeding the time limitation constraint value. It may be a file delete command separately sent for each file or one delete command for a list of file names. The file system deletes each file for which a delete command is issued and it generates and sends a delete acknowledgement to the cloud synchronization function. The cloud synchronization function receives in S740 said delete acknowledgements from the file system.

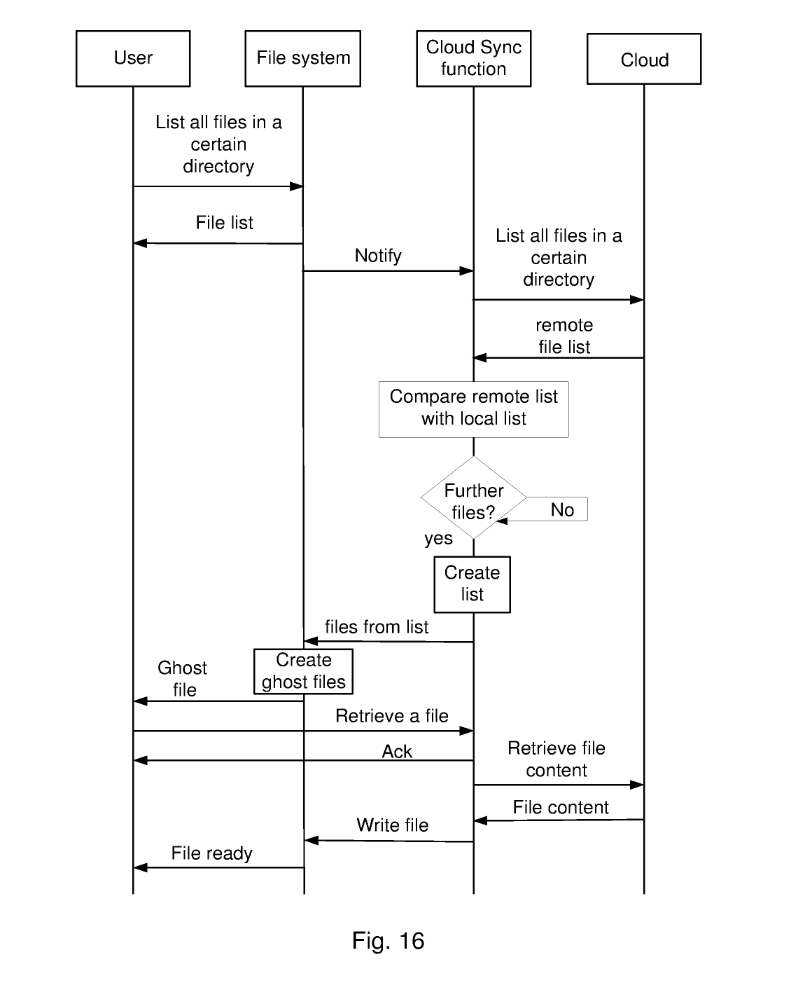

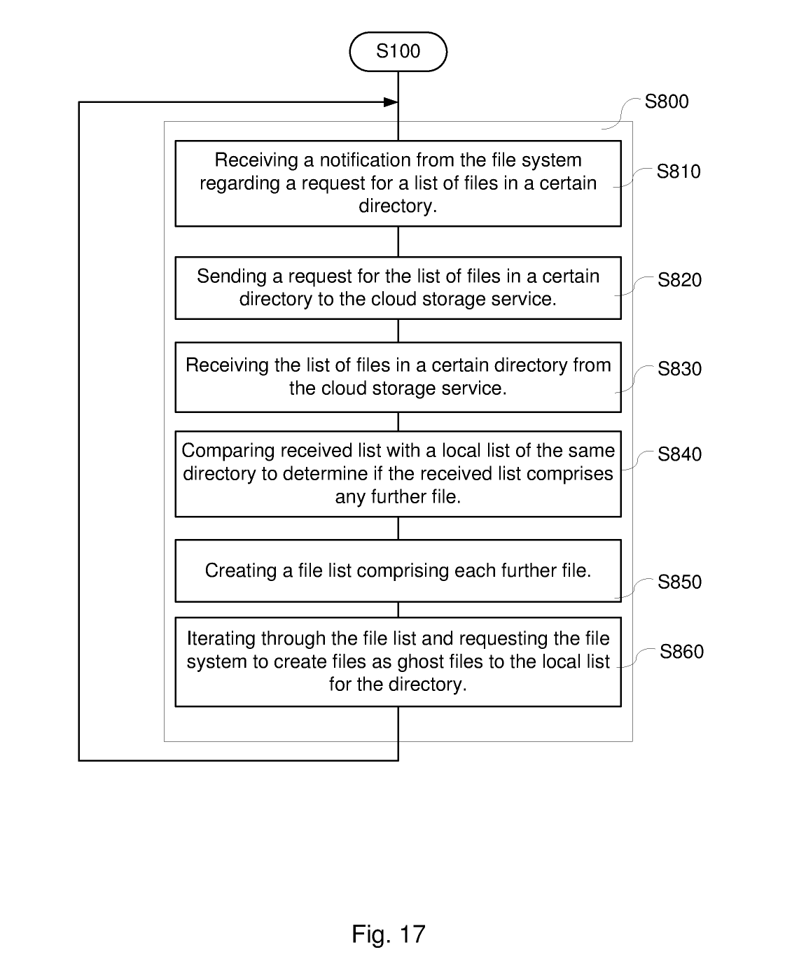

The cloud synchronization function may also be configured not to download any file content automatically. In this case the file can be shown, for example, as a “ghost” file icon. A ghost file icon is greyed out on the user device display. The corresponding file to the greyed out file icon is herein denoted as a ghost file or empty file. Technically, an empty file is created on a target device file system holding only metadata and extended metadata (file ID and version) with a pointer to the file in the cloud. This sub-process S800 is described below with reference to FIGS. 16 and 17.

FIG. 16 is a signaling scheme comprising the sub-process S800. The user instructs the file system to “request a list of all files in a certain directory”. The file system has a first list, or local list, of files in the specified directory. However, said local list may not be complete if the list comprises one or more cloud tagged files. The file system is therefore triggered by the cloud tagged files to forward the request to the cloud synchronization function, which receives the request in a step S810 and forwards said request in a notification message, notify, to the cloud storage service in a step S820. The cloud storage service performs a search for the files in the specified directory. The search results in a second list of files, a remote list, which is sent to the user device and received by the cloud synchronization function in step S830. The received list, i.e. remote list, does not contain any content belonging to the file names.

The file system provides the local list of files in said directory. The cloud synchronization function compares in step S840 the remote and local lists to find files that is present in the remote list but not in the local list. Said further files, i.e. missing files in the local list, are listed in a new file list in a step S850 by the cloud synchronization function. In a following step S860, the synchronization function iterates through the file list and instructs the file system to add the further files as ghost files to the local list for the directory. Thus, the further files are sent to the file system together with instructions to create a ghost file for each of said files in the list. The file system is adapted to create a ghost file for each of said further files, and to add the ghost files to the local list for the directory of interest. The new local list with the added ghost files is regarded as a complete list for the directory.

The user is now able to look at the complete list for the directory on a display and order to retrieve any file from the file system.

The sub-process S800 that enables the above described process to be performed is illustrated in FIG. 17. The cloud synchronization function is adapted to:

S810: receiving a notification from the file system regarding a request for a list of files in a certain directory;
S820: sending a request for the list of files in a certain directory to the cloud storage service;
S830: receiving the list of files in a certain directory from the cloud storage service;
S840: comparing received list with a local list of the same directory to determine if the received list comprises any further file;
S850: creating a file list comprising each further file;
S860: iterating through the file list and instructing the file system to add the further files as ghost files to the local list for the directory.

If the user tries to open a ghost file, the file system forwards the order to the cloud synchronization function, which receives the order and generates an acknowledgement to the user. The cloud synchronization function sends the order to the cloud storage service, which responds by sending the file content and extended metadata to the user device. The cloud synchronization function writes the file and its content into the file system, which informs the user (by means of the display) that the file is ready to use.

A very common scenario is that the user has some file under $HOME directory, while having different user accounts on different devices which means different name of $HOME directory. For example, the $HOME directory could be different on Mac and Windows, “/Users/foo” on Mac and “C:/Users/foo” on Windows, or even on the same OS but different user names, “/Users/foo” and “/Users/bar”.

But if the user wants to synchronize files regardless of path leading to $HOME directory then the user can give a hint when tagging the file that relative path shall be used to determine whether to sync it to other devices.

A profile contains mappings between local files in a file system and files in a cloud. A user may have multiple profiles. For example, the user has one profile for Windows, and another profile for Linux; also may have different profiles for different users. Name and content of a profile is defined and controlled purely by the user.

As an extension to the handling of profiles, multiple profiles can be associated with the user that correspond to different file system structures, e.g. for different operating systems. Profiles can also be shared among users at will.

The user can configure the cloud synchronization function to work in and use profile A under OS X, and profile B under OS Y.

Thus, said method S100 may further comprise a sub-process of handling profiles, i.e. user profile, wherein a cloud tagged file in a first profile is linked to a second profile having a second cloud tagged

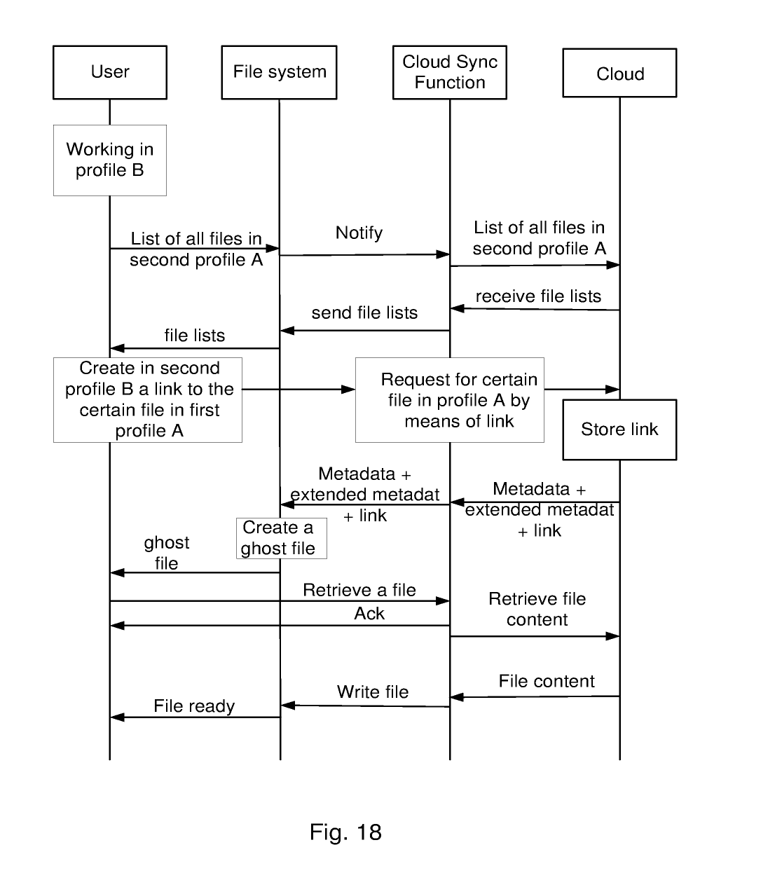

FIG. 18 is a signaling scheme comprising the sub-process S900.

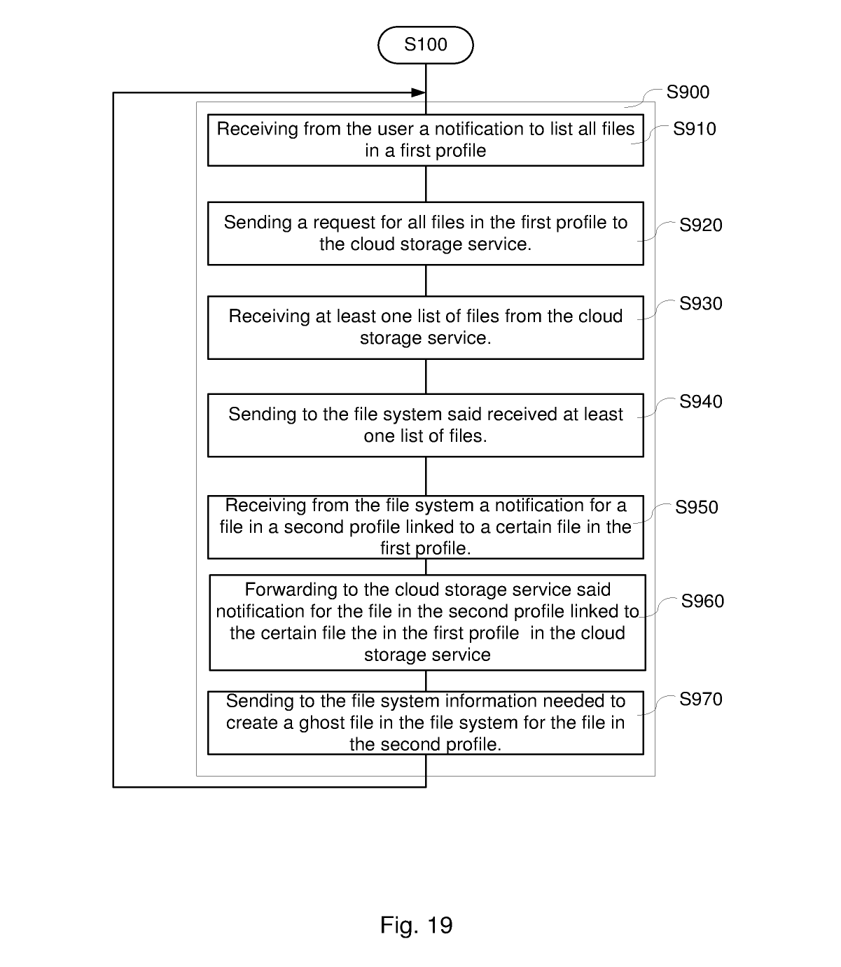

FIG. 19 is a flowchart comprising the steps of the sub-process S900.

The sub-process S900 is described below with reference to FIGS. 18 and 19.

In general the idea is to enable the user to link files from different profiles.

For example the user has a file a1 that is cloud tagged in a first profile A stored in the cloud storage service. Said file a1 is present in the file system of the first device. Later on the user switches to a second device which is using a second profile B. One problem arise if the user wants to read/write the same file a1 that does not exist in the second profile B of the second device but exist in the first profile A of the first device.

This is solved as follows from a user's point of view:
the user imports to the second device a list of the files in the first profile A in the cloud storage service;
the user locates the file a1 in said list of profile A;
the user links the file a1 to a new file under the second profile B, naming it as b1. So from then on, a1 and b1 point to the same file in the cloud storage of the cloud storage service.
the user is enabled by means of the link to download the content of file a1 to the local file system of the second user device.

The cloud synchronization function is capable of retrieving a file and its content by means of the link information stored in the profile of the cloud storage service.

The relation between profiles and the actual cloud storage service is illustrated by the following stored metadata tables:

If the user cloud tags a file in profile A, pa in the drawing, and then switches to profile B, pb in the drawing, he/she can create a link back to the file a1 in profile A, and in this case, those two files are considered to be the same.

Here “ID=a1” and “ID=b1” point to the same file with ID “1” in the cloud storage.

A profile can be automatically selected based on current operating system or can be specified by the user explicitly.

The profile itself is also stored in the cloud storage service.

With reference to FIG. 18, the user instructs the file system to “request a list of all files in a first profile A”.

The file system has no list, or local list, of files in the specified first profile A as it is provided by another device. The file system is therefore triggered to forward the request to the cloud synchronization function, which receives the request in a notification message, “notify”, in a step S910 and forwards said request to the cloud storage service in a step S920. The cloud storage service performs a search for the files in the specified first profile A. The search results in at least one file list, which is sent to the user device and received by the cloud synchronization function in step S930. The received list or lists do not contain any content belonging to the file names in the list or list for the first profile A.

In a following step S940, the cloud synchronization function sends the received files to the file system, which forwards the file list or file lists to the display unit of the user device.

The user is now able to look at the list or lists of the first profile A on a display and order to retrieve any file from the list.

The user selects a certain file in the first profile A. The user links the file to a new file under the second profile B by giving the file a name in profile B. The new name in the second profile is linked to the name of the first profile and its corresponding metadata.

The user is now enabled by means of the link and the cloud synchronization function to download the content of the file to the local file system of the second user device.

The sub-process is adapted to create in the second profile B a ghost file linked to the certain file in the first profile A.

The user sends a request for the file to the file system. The file system notifies the cloud synchronization function, which in a step S950 receives from the file system the notification for the file which is linked to the file the first profile A.

The cloud synchronization function is adapted to, in a step S960, forward said the notification for the file which is linked to the file the first profile A in the cloud storage service. The cloud storage service stores the link in a list of links between files in different profiles and returns extended metadata to the cloud synchronization function.

The cloud synchronization function sends to the file system in a step S970 information needed to create a ghost file in the file system for the file in the second profile B.

If the user tries to open said ghost file, which has no file content, the file system forwards the order to the cloud synchronization function, which receives the order and generates an acknowledgement to the user. The cloud synchronization function further sends the order to the cloud storage service, which responds by sending the file content and extended metadata for the file in the second profile B stored in the cloud storage service to the user device. The cloud synchronization function writes the file and its content into the file system, which informs the user (by means of the display) that the file is ready to use. i.e. the file is no ghost any longer.

The sub-process S900 that enables the above described process to be performed in the cloud synchronization function is illustrated in a flowchart of FIG. 19. The cloud synchronization function is adapted to:

S910: receiving from the user a notification to list all files in a first profile A stored in the cloud storage service;
S920: sending a request for all files in the first profile A to the cloud storage service;
S930: receiving at least one list of files of the first profile A from the cloud storage service;
S940: sending to the file system said received at least one list of files;
S950: receiving from the file system a notification for a file in a second profile linked to a certain file in the first profile;
S960: forwarding to the cloud storage service said notification for the file in the second profile B linked to the certain file in the first profile in the cloud storage service;
S970: sending to the file system information needed to create a ghost file in the file system for the file in the second profile.

The information needed to create a ghost file, which is an empty file, is only metadata and extended metadata (file ID and version) with the link to the file in the cloud.

By means of said metadata and extended metadata and the link, the user device and file system is able to request the content of the file.

The technique may be implemented in digital electronically circuitry, or in computer hardware, firmware, software, or in combinations of them. Apparatus of the herein proposed technique may be implemented in a computer program product tangibly embodied in a machine readable storage device for execution by a programmable processor; and method steps of the technique may be performed by a programmable processor executing a program of instructions to perform functions of the technique by operating on input data and generating output.

The technique may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of non-volatile memory, including by way of example semiconductor memory devices, such as EPROM (erasable programmable read only memory), EEPROM (electrically erasable programmable read only memory), and flash memory devices; magnetic disks such internal hard disks and removable disks; magneto-optical disks; and CD-ROM (Compact Disc Read-Only Memory) disks. Any of the foregoing may be supplemented by, or incorporated in, specially designed ASICs (Application Specific Integrated Circuits).

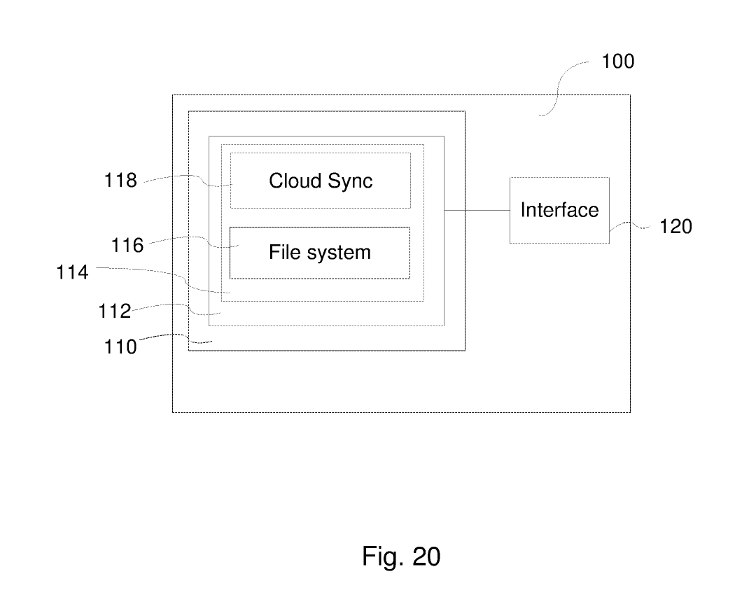

FIG. 20 is a block diagram illustrating a user device comprising a cloud synchronization function means.

The user device 100 is handled by a user that is able to control the device by pressing keys on a keyboard, entering commands, starting software applications (Apps), etc. The user device comprises an operating software system 114 running in a processor unit 110 comprising one or more processors 112 and memory storages. The user device comprises a file system 116 for enabling the user to handle files and directories storing the files. The device further comprises a communication interface 120 for enabling transmission and reception of data packets comprising commands, messages, calls, files, etc.

The user device further comprises a cloud synchronization function means 118 for enabling transferring of files or directories between the file system 116 of the user device and the cloud storage service in the cloud. The file system is adapted to generate and send, when or if it finds a file or directory that has been cloud tagged, a notification to the cloud synchronization function that one or more files in the file system have been cloud tagged. The file system may also be adapted to receive a cloud tag into the name of a stored filed. The file system is a computer software, which is executable by the processor unit. By adapting the file system to perform a certain step of method, method or process, the processor unit is adapted to perform said certain step, method or process.

The cloud storage service is a service offering storage of files of different kinds in the cloud, or internet.

The cloud synchronization function means 118 is a functionality block for handling files and directories in a cloud storage service. The user device comprises a processing unit 110, which is adapted to perform:
receiving a notification from a file system 116 of the user device that one or more files in the file system have been cloud tagged by a user of the user device to be synchronized with the cloud storage service;
retrieving the cloud tagged file or files from the file system;
sending the cloud tagged file or files to the cloud storage service.

Said processing unit may be adapted to perform:
receiving metadata for the cloud tagged file or files from the file system;
sending the received metadata of the cloud tagged file or files to the cloud storage service.

Said processing unit may further be adapted to perform:
receiving extended metadata of the cloud tagged file or files from the cloud storage service;
sending the received extended metadata of the cloud tagged file or files to the file system;
retrieving an updated cloud tagged file and corresponding metadata from the file system;
sending the updated cloud tagged file and corresponding metadata to the cloud storage service.

According to one embodiment of the cloud synchronization function means, said processing unit is adapted to delete the cloud tagged file or files by sending to the cloud storage service a delete command of the cloud tagged file or files upon reception of a cloud tag deletion notification of said file or files;
receiving from the cloud storage service a de-tagging command to remove cloud tag of one or more indicated cloud tagged files in the file system;
removing cloud tag from the indicated cloud tagged files in the file system.

The cloud synchronization function means and its processing unit may further be adapted to perform a sub-process of listing all versions of a cloud tagged file in the cloud storage service and download a specific version of the file from the cloud storage service into the file system.

According to yet another embodiment, the cloud synchronization function and its processing unit may be adapted to perform a sub-process of listing all new added cloud tagged files in the cloud storage service and download new added cloud tagged files from the cloud storage service into the file system.

The cloud synchronization function means and its processing unit is in further one embodiment adapted to perform a sub-process of automatically retrieving a cloud tagged file from the cloud storage service to the file system upon an access file command.

Another embodiment of the cloud synchronization function means is also provided, wherein said processing unit is adapted to perform a sub-process of checking if cloud tagged files could be deleted due to a time limit. Said sub-process comprises the steps of:
retrieving a time parameter for each cloud tagged file from the file system;
comparing the time limit to a time limitation constraint value;
sending a file delete command to the file system for each file exceeding the time limitation constraint value;
receiving a delete acknowledgement from the file system.

Further one embodiment of the cloud synchronization function means is provided, wherein its processing unit is adapted to perform a sub-process of handling files, wherein each file is identified by metadata and extended metadata without comprising its file content. The cloud synchronization function means supports the sub-process comprising:
receiving a notification from the file system regarding a request for a list of files in a certain directory;
sending a request for the list of files in a certain directory to the cloud storage service;
receiving the list of files in a certain directory from the cloud storage service;
comparing received list with a local list of the same directory to determine if the received list comprises each further file;
creating a file list comprising each further file;
iterating through the file list and requesting the file system to create files as ghost files to the local list for the directory.

Another sub-process of handling profiles may be supported by the cloud synchronization function means. In said sub-process, a cloud tagged directory in a first profile is linked to a second profile having a second cloud tagged directory by means of the cloud tagging. According to this embodiment, the cloud synchronization function means and its processing unit is adapted to perform:
receiving from the user a notification to list all files in a first profile A stored in the cloud storage service;
sending a request for all files in the first profile A to the cloud storage service;
receiving at least one list of files of the first profile A from the cloud storage service;
sending to the file system said received at least one list of files;
receiving from the file system a notification for a file in a second profile linked to a certain file in the first profile;
forwarding to the cloud storage service said notification for the file in the second profile B linked to the certain file in the first profile in the cloud storage service;
sending to the file system information needed to create a ghost file in the file system for the file in the second profile.

In FIG. 20, a file system 116 is also illustrated. The file system 116 of a user device 100, wherein the user device comprises a processing unit 110 capable of handling said file system, which processing unit 110 is adapted to generate and send a notification to a cloud synchronization function 118 of the user device that one or more files in the file system have been cloud tagged.

The file system 116 may further be adapted to receive a cloud tag into the name of a stored filed in the file system. The user decides whether a file should be tagged or not.

The entities and units described above with reference to FIG. 20 are logical units, and do not necessarily correspond to separate physical units. Thus, the person skilled in the art would appreciate that the units disclosed in FIG. 20 may be implemented as physically integrated units, and/or physically separate units, and that the units are provided with appropriate processing circuits.

A number of embodiments of the present technique have been described. It will be understood that various modifications may be made without departing from the scope of the subject-matter of the enclosed claims. Therefore, other implementations are within the scope of the following claims.

1-26. (canceled)

27. A method, in a user device, of handling files and directories in a cloud storage service, said method comprising the steps of:
receiving a notification from a file system of the user device that one or more files in the file system have been cloud tagged by a user of the user device to be synchronized with the cloud storage service;
retrieving the cloud tagged file or files from the file system; and
sending the cloud tagged file or files to the cloud storage service.

28. The method of claim 27, further comprising the steps of:
receiving metadata for the cloud tagged file or files from the file system; and
sending the received metadata of the cloud tagged file or files to the cloud storage service.

29. The method of claim 27, further comprising the steps of:
receiving extended metadata of the cloud tagged file or files from the cloud storage service; and
sending the received extended metadata of the cloud tagged file or files to the file system.

30. The method of claim 27, further comprising the steps of:
retrieving an updated cloud tagged file and corresponding metadata from the file system; and
sending the updated cloud tagged file and corresponding metadata to the cloud storage service.

31. The method of claim 27, further comprising the step of:
sending to the cloud storage service a delete command of the cloud tagged file or files upon reception of a cloud tag deletion notification of said file or files.

32. The method of claim 31, further comprising the steps of:
receiving from the cloud storage service a de-tagging command to remove cloud tag of one or more indicated cloud tagged files in the file system; and
removing cloud tag from the indicated cloud tagged files in the file system.

33. The method of claim 27, wherein said method comprises a sub-process of listing all versions of a cloud tagged file in the cloud storage service and downloading a specific version of the file from the cloud storage service into the file system.

34. The method of claim 27, wherein said method comprises a sub-process of listing all new added cloud tagged files in the cloud storage service and downloading new added cloud tagged files from the cloud storage service into the file system.

35. The method of claim 27, wherein said method comprises a sub-process of automatically retrieving a cloud tagged file from the cloud storage service to the file system upon an access file command.

36. The method of claim 27, wherein said method comprises a sub-process of checking whether cloud tagged files could be deleted due to a time limit, said sub-process comprising the steps of:
retrieving a time parameter for each cloud tagged file from the file system;
comparing the time limit to a time limitation constraint value;
sending a file delete command to the file system for each file exceeding the time limitation constraint value; and
receiving a delete acknowledgement from the file system.

37. The method of claim 27, wherein said method comprises a sub-process of handling files, wherein each file is identified by metadata and extended metadata without comprising its file content, and wherein said sub-process comprises:
receiving a notification from the file system regarding a request for a list of files in a certain directory;
sending a request for the list of files in a certain directory to the cloud storage service;
receiving the list of files in a certain directory from the cloud storage service;
comparing received list with a local list of the same directory to determine if the received list comprises any further file;
creating a file list comprising each further file; and
iterating through the file list and requesting the file system to create files as ghost files to the local list for the directory.

38. The method of claim 27, wherein said method comprises a sub-process of handling profiles, wherein a cloud tagged directory in a first profile is linked to a second profile having a second cloud tagged directory by means of the cloud tagging, and wherein the sub-process comprises:
receiving from the user a notification to list all files in a first profile stored in the cloud storage service;
sending a request for all files in the first profile to the cloud storage service;
receiving at least one list of files of the first profile from the cloud storage service;
sending to the file system said received at least one list of files;
receiving from the file system a notification for a file in a second profile linked to a certain file in the first profile;
forwarding to the cloud storage service said notification for the file in the second profile linked to the certain file in the first profile in the cloud storage service; and
sending to the file system information needed to create a ghost file in the file system for the file in the second profile.

39. A user device adapted to include a cloud synchronization function for handling files and directories in a cloud storage service, wherein the user device comprises a processing circuit configured to:
receive a notification from a file system of the user device that one or more files in the file system have been cloud tagged by a user of the user device to be synchronized with the cloud storage service;
retrieve the cloud tagged file or files from the file system; and
send the cloud tagged file or files to the cloud storage service.

40. The user device of claim 39, wherein the processing circuit is configured to:
receive metadata for the cloud tagged file or files from the file system; and
send the received metadata of the cloud tagged file or files to the cloud storage service.

41. The user device of claim 39, wherein the processing circuit is configured to:
receive extended metadata of the cloud tagged file or files from the cloud storage service; and
send the received extended metadata of the cloud tagged file or files to the file system.

42. The user device of claim 39, wherein the processing circuit is configured to:
retrieve an updated cloud tagged file and corresponding metadata from the file system; and
send the updated cloud tagged file and corresponding metadata to the cloud storage service.

43. The user device of claim 39, wherein the processing circuit is configured to:
send to the cloud storage service a delete command of the cloud tagged file or files upon reception of a cloud tag deletion notification of said file or files.

44. The user device of claim 43, wherein the processing circuit is configured to:
receive from the cloud storage service a de-tagging command to remove cloud tags of one or more indicated cloud tagged files in the file system; and
remove cloud tags from the indicated cloud tagged files in the file system.

45. The user device of claim 39, wherein the processing circuit is configured to perform a sub-process of listing all versions of a cloud tagged file in the cloud storage service and downloading a specific version of the file from the cloud storage service into the file system.

46. The user device of claim 39, wherein the processing circuit is configured to perform a sub-process of listing all new added cloud tagged files in the cloud storage service and downloading new added cloud tagged files from the cloud storage service into the file system.

47. The user device of claim 39, wherein the processing circuit is configured to perform a sub-process of automatically retrieving a cloud tagged file from the cloud storage service to the file system upon an access file command.

48. The user device of claim 39, wherein the processing circuit is configured to perform a sub-process of checking whether cloud tagged files could be deleted due to a time limit, said sub-process comprising the steps of:
retrieving a time parameter for each cloud tagged file from the file system;
comparing the time limit to a time limitation constraint value;
sending a file delete command to the file system for each file exceeding the time limitation constraint value; and
receiving a delete acknowledgement from the file system.

49. The user device of claim 39, wherein the processing circuit is configured to perform a sub-process of handling files, wherein each file is identified by metadata and extended metadata without comprising its file content, and wherein said sub-process comprises:
receiving a notification from the file system regarding a request for a list of files in a certain directory;
sending a request for the list of files in a certain directory to the cloud storage service;
receiving the list of files in a certain directory from the cloud storage service;
comparing received list with a local list of the same directory to determine if the received list comprises each further file;
creating a file list comprising each further file; and
iterating through the file list and requesting the file system to create files as ghost files to the local list for the directory.

50. The user device of claim 39, wherein the processing circuit is configured to perform a sub-process of handling profiles, wherein a cloud tagged directory in a first profile is linked to a second profile having a second cloud tagged directory by means of the cloud tagging, said sub-process comprising:
receiving from the user a notification to list all files in a first profile stored in the cloud storage service;
sending a request for all files in the first profile to the cloud storage service;
receiving at least one list of files of the first profile from the cloud storage service;
sending to the file system said received at least one list of files;
receiving from the file system a notification for a file in a second profile linked to a certain file in the first profile;
forwarding to the cloud storage service said notification for the file in the second profile linked to the certain file in the first profile in the cloud storage service;
sending to the file system information needed to create a ghost file in the file system for the file in the second profile.

51. A user device comprising a processing circuit and a file system, wherein the processing circuit is configured to handle said file system, and is further configured to generate and send, to a cloud synchronization function, a notification that one or more files in the file system have been cloud tagged.

52. The user device of claim 51, wherein the file system is adapted to receive a cloud tag into the name of a stored filed in the file system.
